(19) United States
(12) Patent Application Publication
(10) Pub. No.: US 2009/0136793 A1
(43) Pub. Date: May 28, 2009

(54) HYDROGEN SUPPLY FOR A FUEL CELL SYSTEM

(76) Inventor: Yoshihito Kanno, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/279,242

(22) PCT Filed: Feb. 5, 2007
(86) PCT No.: PCT/IB07/00273

§ 371 Date: Aug. 13, 2008

(30) Foreign Application Priority Data
Feb. 14, 2006 (JP) 2006-036590
Feb. 15, 2006 (JP) 2006-037704

(51) Int. Cl. H01M 8/04

(52) U.S. Cl. 429/13; 429/22

(57) ABSTRACT

A fuel cell system characterized by including: a fuel cell (1) that generates electricity through electrochemical reactions between a hydrogen gas and an oxidizing gas; a hydrogen supply device (2) for supplying the hydrogen gas to the fuel cell; a hydrogen supply passage (21) through which the hydrogen gas supplied from the hydrogen supply device passes; an anode off-gas passage (22) through which an anode off-gas discharged from the anode side of the fuel cell passes; a hydrogen concentration sensor (3) provided on at least one of the hydrogen supply passage (21) and the anode off-gas passage (22); and a correction device (4) that reduces impurities in the passage provided with the hydrogen concentration sensor, measures hydrogen concentration using the hydrogen concentration sensor and corrects a reference point of the hydrogen concentration sensor based on the measured hydrogen concentration.

### BACKGROUND OF THE INVENTION

1. Field of the Invention

The present invention relates to a fuel cell system that generates electric energy through electrochemical reactions.

2. Description of the Related Art

Fuel cell systems supply a fuel gas, such as a hydrogen gas, and an oxidizing gas containing oxygen to a fuel cell or fuel cells to cause these gases to electrochemically react with each other through an electrolyte of the fuel cell in order to obtain electric energy.

A fuel cell system of the related art is provided with a hydrogen concentration sensor on an anode off-gas passage through which an anode off-gas discharged from the fuel cell passes, and measures the concentration of the hydrogen contained in the anode off-gas (see Japanese Patent Application Publication No. 2004-95300 (JP-A-2004-95300), for example).

The hydrogen concentration measured by the hydrogen concentration sensor is used to perform various control operations of the fuel cell system, such as regulating the amount of the anode off-gas discharged from the fuel cell. The hydrogen concentration sensor is therefore required to have high measurement accuracy. However, the accuracy of the hydrogen concentration sensor can decrease as it is used for a long time, which can cause an error.

### SUMMARY OF THE INVENTION

An object of the present invention is to suppress the measurement error of a hydrogen concentration sensor and maintain the measurement accuracy of the hydrogen concentration sensor even after long-term use in a fuel cell system provided with the hydrogen concentration sensor that measures hydrogen concentration.

A first aspect of the present invention relates to a fuel cell system including a fuel cell that generates electricity through electrochemical reactions between a hydrogen gas and an oxidizing gas. The fuel cell system includes: the fuel cell; a hydrogen supply device for supplying the hydrogen gas to the fuel cell; a hydrogen supply passage through which the hydrogen gas supplied from the hydrogen supply device passes; an anode off-gas passage through which an anode off-gas discharged from the anode side of the fuel cell passes; a hydrogen concentration sensor provided on at least one of the hydrogen supply passage and the anode off-gas passage; and a correction device that reduces impurities in the passage provided with the hydrogen concentration sensor, measures hydrogen concentration using the hydrogen concentration sensor and corrects a reference point of the hydrogen concentration sensor based on the measured hydrogen concentration.

The fuel cell system according to the first aspect may further include: a release valve, provided on the anode off-gas passage, for discharging the impurities contained in the anode off-gas from the system, wherein the hydrogen concentration sensor may be provided upstream of the release valve on the anode off-gas passage, and the impurities may be reduced by discharging the anode off-gas by a predetermined amount or more by opening the release valve, while supplying the hydrogen gas using the hydrogen supply device.

The fuel cell system according to the first aspect includes the correction device for correcting the reference point of the hydrogen concentration sensor. By correcting the measurement value from the sensor using the correction device, it is possible to correct the reference point of the sensor. The correction device corrects the measurement value from the sensor based on the hydrogen concentration measured by the hydrogen concentration sensor when the anode off-gas has been discharged by the predetermined amount or more from the system while supplying the hydrogen gas using the hydrogen supply device, that is, when the impurities have been reduced. In addition, because it is possible to discharge the anode off-gas by opening the release valve, it is possible to discharge the anode off-gas from the system using a simple construction.

In general, an impure gas containing, in addition to the hydrogen that was not used to generate electricity, the nitrogen that has been transmitted to the anode side through the electrolyte film is discharged from the anode side of the fuel cell. For this reason, in the anode off-gas passage, there is a mixture of various impurity gases in addition to hydrogen gas. If the gas in the anode off-gas passage is discharged from the system while supplying the hydrogen gas, the various gases are discharged, and the impurities are reduced. As a result, the hydrogen concentration increases due to the supplied hydrogen gas. The hydrogen concentration in the anode off-gas passage is influenced by whether the fuel cell is generating electricity, and the permeability of the electrolyte film of the fuel cell. However, when the amount of the anode off-gas discharged from the anode off-gas passage becomes equal to or greater than a certain amount, the hydrogen concentration in the anode off-gas passage becomes almost constant.

The fuel cell system of this aspect may discharge the anode off-gas by a predetermined amount or more, measure the hydrogen concentration using the hydrogen concentration sensor when it is supposed that the hydrogen concentration in the anode off-gas passage is substantially constant, and correct the error of the measurement value on the assumption that the difference between the hydrogen concentration that is supposed to be the constant concentration and the measurement value from the hydrogen concentration sensor is the error. The predetermined amount is such that the hydrogen concentration in the anode off-gas passage, which is measured by the hydrogen concentration sensor, is supposed to become a substantially constant concentration when the anode off-gas has been discharged by the predetermined amount and thus the impurities have been reduced. The predetermined amount is appropriately set according to electricity generation conditions of the fuel cell etc.

More specifically, the anode off-gas discharge amount that is such that the measurement value from the hydrogen concentration sensor becomes substantially 100% when the anode off-gas has been discharged by the anode off-gas discharge amount, is calculated in advance as the predetermined amount, and it is assumed that the hydrogen concentration becomes 100% after the anode off-gas has been discharged by the predetermined amount. If the measurement value from the hydrogen concentration sensor is not 100% when the anode off-gas has been discharged by the predetermined amount, the measurement value from the sensor is corrected on the assumption that the difference between the actual measurement value and 100% is the error. By performing such correction at predetermined intervals, it becomes possible to maintain the accuracy in measuring the hydrogen concentration even after long-term use.

If the theoretical hydrogen concentration and the actually measured hydrogen concentration are compared, and the measurement value from the hydrogen concentration sensor is corrected based on the difference therebetween in this way to correct the reference point of the hydrogen concentration sensor, it is possible to appropriately correct the error of the sensor and maintain the measurement accuracy of the hydrogen concentration sensor even if the hydrogen concentration sensor is used for a long time and becomes degraded to cause an error in the measurement value.

The fuel cell system according to this aspect may further include: a bypass passage that leads the hydrogen gas to the anode off-gas passage not through the fuel cell, the bypass passage connecting the hydrogen supply passage and a portion of the anode off-gas passage that is located upstream of the hydrogen concentration sensor, wherein, when the correction device has discharged the anode off-gas by the predetermined amount or more from the system while supplying the hydrogen gas to the anode off-gas passage through the bypass passage, the correction device measures the hydrogen concentration using the hydrogen concentration sensor, and corrects the reference point of the hydrogen concentration sensor.

In the fuel cell, water is produced through electrochemical reactions, and therefore the anode off-gas that passes through the fuel cell can contain moisture. If the anode off-gas contains moisture, the measurement value from the hydrogen concentration sensor can be affected by the moisture. On the other hand, the hydrogen gas introduced through the bypass passage does not contain moisture because the hydrogen gas has not passed through the fuel cell.

If a hydrogen gas is supplied to the anode off-gas passage through the bypass passage when the correction device corrects the reference point of the sensor, the possibility that the measurement value from the hydrogen concentration sensor is affected by the moisture is reduced. As a result, it is possible to improve the measurement accuracy of the hydrogen concentration sensor, and it also becomes possible to improve the accuracy of the correction performed based on the measured concentration.

In the fuel cell system according to this aspect, the predetermined amount concerning the anode off-gas discharge may be such that the hydrogen concentration in the anode off-gas passage measured by the hydrogen concentration sensor is supposed to become substantially 100% when the anode off-gas is discharged by the predetermined amount. The hydrogen concentration approaches 100% as the amount of the anode off-gas discharged from the anode off-gas passage increases. For this reason, the conditions in which the hydrogen concentration in the anode off-gas passage is 100% can contribute to improve the correction accuracy as compared to the case where the hydrogen concentration is another concentration.

The fuel cell system according to this aspect may include: a hydrogen circulation passage that connects the hydrogen supply passage and the anode off-gas passage, and leads the anode off-gas to the hydrogen supply passage, wherein the hydrogen concentration sensor is provided downstream of a joining of the hydrogen supply passage and the hydrogen circulation passage on the hydrogen supply passage, and the impurities is reduced by supplying the hydrogen gas to the fuel cell while regulating the flow of the anode off-gas from the hydrogen circulation passage into the hydrogen supply passage.

The fuel cell system according to this aspect includes the correction device that corrects the hydrogen concentration sensor, and therefore can correct the reference point of the hydrogen concentration sensor by correcting the measurement value from the hydrogen concentration sensor using the correction device. The fuel cell system according to this aspect includes the circulation system that returns, to the fuel cell, the anode off-gas discharged from the fuel cell. The correction device corrects the measurement value from the hydrogen concentration sensor based on the hydrogen concentration measured using the hydrogen concentration sensor after supplying the hydrogen gas from the hydrogen supply device to the fuel cell while regulating the flow of the anode off-gas into the hydrogen supply passage.

The anode off-gas contains not only impurity gases, such as the nitrogen that has been transmitted from the cathode side to the anode side through the electrolyte film while the electricity generation in the fuel cell is stopped, but also the hydrogen gas supplied to the fuel cell. If the anode off-gas is discharged from the system, high-concentration hydrogen gas will be discharged. Accordingly, the anode off-gas is introduced into the hydrogen supply passage through the hydrogen circulation passage, whereby the hydrogen contained in the anode off-gas is returned to the fuel cell to reduce the concentration of the hydrogen discharged.

The hydrogen concentration sensor, provided downstream of the joining of the hydrogen supply passage and the hydrogen circulation passage on the hydrogen supply passage, measures the hydrogen concentration in the gas in the hydrogen supply passage. Various control operations, such as regulating the flow rate of the anode off-gas that is introduced into the fuel cell, are performed based on the measured hydrogen concentration.

The fuel cell system of this aspect measures the hydrogen concentration using the hydrogen concentration sensor under the conditions in which the measurement value from the hydrogen concentration sensor has become a constant value, that is, under the conditions in which the impurities have been reduced and the hydrogen concentration in the hydrogen supply passage has become a constant value, and then corrects the measurement value from the hydrogen concentration sensor on the assumption that the difference between the measurement value and the supposed constant value is the error.

More specifically, hydrogen gas is supplied to the fuel cell using the hydrogen supply device without introducing the anode off-gas into the hydrogen supply passage, so that, instead of the anode off-gas, the pure hydrogen gas supplied from the hydrogen supply device is allowed to flow into the hydrogen supply passage. In this way, impurities are discharged from the passage, and the relationship between the hydrogen concentration in the hydrogen supply passage and the amount of the hydrogen gas supplied from the hydrogen supply device becomes a particular relationship. The hydrogen concentration is actually measured under the conditions in which the hydrogen concentration from the hydrogen concentration sensor is supposed to be the constant concentration, and, if the actual measurement value and the theoretical value are not equal to each other, the measurement value from the hydrogen concentration sensor is corrected on the assumption that the difference between the actual measurement value and the theoretical value is the error.

If the hydrogen concentration is actually measured under the conditions in which the hydrogen concentration can be estimated, and the measurement value from the hydrogen concentration sensor is corrected based on the estimated value to correct the reference point of the hydrogen concentration sensor, it is possible to appropriately correct the reference point of the sensor and maintain the accuracy in measuring the hydrogen concentration even if the hydrogen concentration sensor is used for a long time and becomes degraded to cause an error.

The correction device of the fuel cell system according to this aspect may correct the reference point of the hydrogen concentration sensor when an electricity generation process in the fuel cell is started. While the electricity generation in the fuel cell is stopped, gas pressure in the fuel cell decreases to almost atmospheric pressure. However, in general, the controlled pressure while the fuel cell is generating electricity is higher than atmospheric pressure, and for this reason, when supplying the hydrogen gas is started at the time of starting electricity generation, hydrogen gas flows into the hydrogen supply passage, and the hydrogen concentration near the hydrogen concentration sensor becomes high. Accordingly, by performing the correction after starting the electricity generation in the fuel cell, it becomes easy to lead the measurement value of the hydrogen concentration sensor to an arbitrary constant value, and it therefore becomes possible to improve the correction accuracy.

When the correction device has supplied the hydrogen gas to the fuel cell by a predetermined amount using the hydrogen supply device, the correction device may measure the hydrogen concentration using the hydrogen concentration sensor, and correct the reference point of the hydrogen concentration sensor.

The hydrogen concentration near the hydrogen concentration sensor varies depending on the amount of the hydrogen gas supplied from the hydrogen supply device. Because the correction can be performed with an appropriate hydrogen concentration by previously calculating the hydrogen gas supply amount that makes the hydrogen concentration near the hydrogen concentration sensor a predetermined value, and correcting the reference point of the hydrogen concentration sensor when the hydrogen gas has been supplied by the calculated amount. Thus, it is possible to improve the correction accuracy.

It is preferable that the predetermined amount be appropriately set according to the spatial volume of the hydrogen supply passage, etc. When the correction by the correction device is performed under the conditions in which the hydrogen concentration is supposed to be substantially 100%, for example, the amount of the hydrogen gas that makes the hydrogen concentration near the hydrogen concentration sensor substantially 100% is calculated in advance, and the correction is performed when the hydrogen gas has been supplied by this amount. In this way, the correction is performed under the conditions in which the hydrogen concentration near the hydrogen concentration sensor is supposed to be approximately 100%, so that it is possible to improve the correction accuracy.

The fuel cell system according to the present invention makes it possible to correct the error of the hydrogen concentration sensor, and it therefore becomes possible to maintain the measurement accuracy of the hydrogen concentration sensor even after long-term use.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a configuration diagram of a fuel cell system according to an embodiment;

FIG. 2 is a flow chart showing a process performed by the fuel cell system according to the embodiment;

FIG. 3 is a configuration diagram of a fuel cell system according to another embodiment;

FIG. 4 is a configuration diagram of a fuel cell system according to another embodiment; and

FIG. 5 is a flow chart showing a process performed by the fuel cell system according to the embodiment.

### DETAILED DESCRIPTION OF THE PREFERRED EMBODIMENTS

Embodiments of fuel cell systems according to the present invention will be described in detail with reference to the drawings.

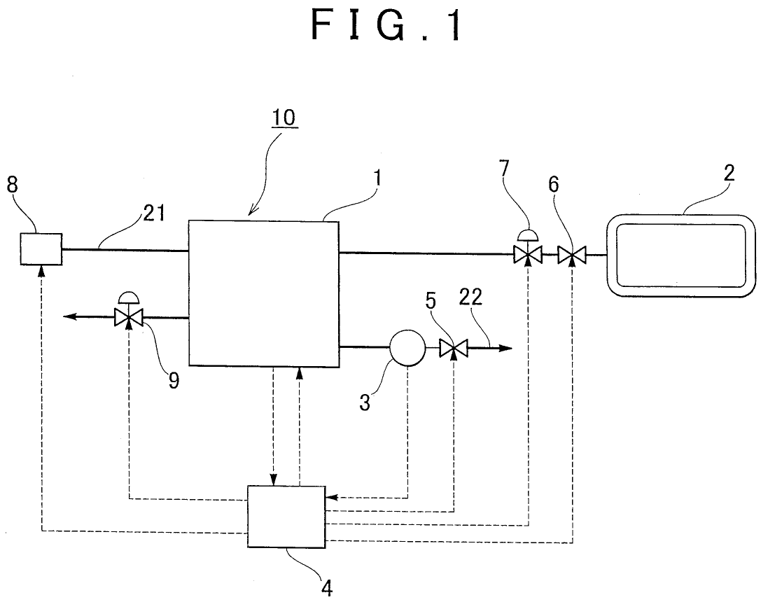

FIG. 1 is a configuration diagram of a fuel cell system according to a first embodiment. The fuel cell system 10 includes: a fuel cell 1 that generates electricity through electrochemical reactions between a hydrogen gas and an oxidizing gas; a high-pressure hydrogen tank 2 as a hydrogen supply device that supplies the hydrogen gas to the fuel cell 1, the high-pressure hydrogen tank 2 storing the hydrogen gas as a fuel gas; a release valve 6 of the high-pressure hydrogen tank 2; a regulator valve 7 for regulating the pressure of the hydrogen gas discharged from the high-pressure hydrogen tank 2; an oxidizing gas supply passage 21 through which air to be supplied to the fuel cell 1 passes; an air compressor 8, provided on the oxidizing gas supply passage 21, that supplies the oxidizing gas to the fuel cell 1; an anode off-gas passage 22 through which anode off-gas discharged from the anode side of the fuel cell 1 passes; a hydrogen concentration sensor 3, provided on the anode off-gas passage 22, that measures the concentration of hydrogen in the anode off-gas; an ECU 4 that performs various control operations, such as control of hydrogen gas supply by the high-pressure hydrogen tank 2, control of oxidizing gas supply, etc.; a release valve 5, provided downstream of the hydrogen concentration sensor 3 on the anode off-gas passage 22, for discharging the anode off-gas from the system; and a regulator valve 9 for regulating the pressure of the cathode off-gas discharged from the cathode side of the fuel cell 1.

The hydrogen concentration sensor 3 measures the hydrogen concentration in the anode off-gas that passes through the anode off-gas passage 22. The value measured by the hydrogen concentration sensor 3 is input to the ECU 4. The ECU 4 performs the opening/closing operation of the release valve 5 based on the hydrogen concentration to discharge impurity gas, such as nitrogen gas when the electricity generation process in the fuel cell 1 is taking place.

When hydrogen gas is supplied from the high-pressure hydrogen tank 2 to the anode side of the fuel cell 1, the hydrogen present on the anode side turns into hydrogen ions, which pass through an electrolyte film to react with oxygen. The hydrogen that was not consumed in the reaction is discharged as the anode off-gas together with the nitrogen that has been transmitted to the anode side.

The release valve 5 discharges the anode off-gas in the anode off-gas passage 22. If discharging the anode off-gas is continued with the hydrogen gas being supplied from the high-pressure hydrogen tank 2, the transmitted nitrogen, etc. are discharged, so that the hydrogen concentration in the anode off-gas passage 22 increases due to the supplied hydrogen gas.

In this embodiment, the relationship between the amount of anode off-gas discharged while the hydrogen gas is supplied to the fuel cell 1 and the hydrogen concentration in the anode off-gas passage 22 at the time point the anode off-gas has been discharged by this amount is previously determined; and the discharge amount that makes the hydrogen concentration in the anode off-gas passage 22 provided with the hydrogen concentration sensor 3 substantially 100% is set as a predetermined amount. When the anode off-gas is discharged by the predetermined amount, the hydrogen concentration is measured using the hydrogen concentration sensor 3, and the measurement value from the hydrogen concentration sensor 3 is corrected on the assumption that the difference between the measurement value and 100%, which is a theoretical value, is an error.

In addition, in this embodiment, the correction value for the hydrogen concentration sensor 3 is calculated when the electricity generation by the fuel cell 1 is stopped, and, based on the hydrogen concentration that reflects the calculated correction value, various control operations of the fuel cell system 10, such as regulating the amount of discharged anode off-gas, are performed.

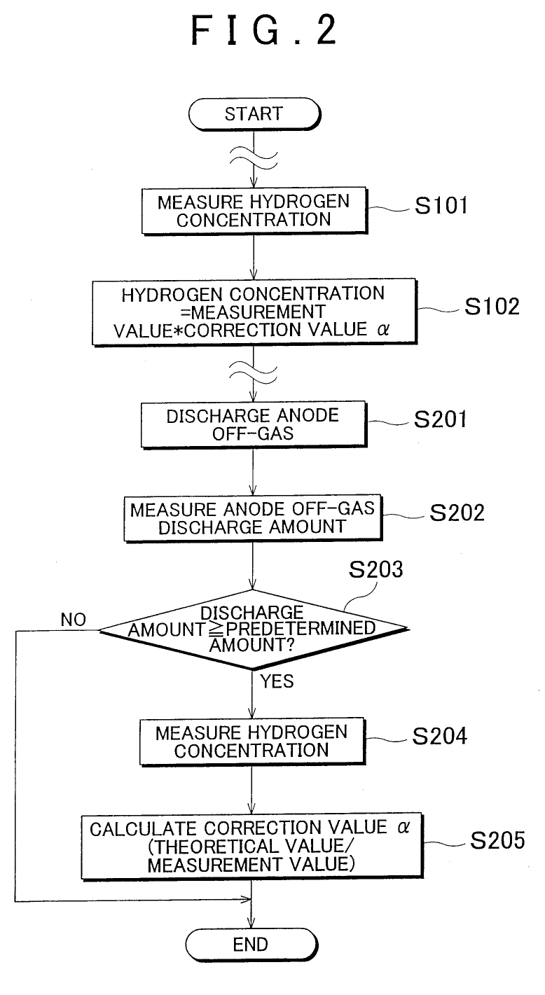

The sensor correction control performed in the fuel cell system 10 constructed as described above will be described in detail below. Various control operations described hereinafter are included in a routine that is executed by the ECU 4, and is repeated at regular intervals. FIG. 2 is a flow chart showing the sensor correction control according to this embodiment.

When the electricity generation process in the fuel cell 1 is taking place, the ECU 4 sends, to the hydrogen concentration sensor 3, a command to measure the hydrogen concentration in the anode off-gas passing through the anode off-gas passage 22 (S101). A purpose of this is to regulate the amount of the anode off-gas that is discharged from the fuel cell 1 based on the hydrogen concentration.

Step S102 is a step of multiplying the hydrogen concentration measured in step S101 by the correction value α, described later, to set the hydrogen concentration. In this embodiment, various control operations are performed using, as the hydrogen concentration, the value obtained by multiplying the value actually measured by the hydrogen concentration sensor 3 by the correction value α. Accordingly, various control operations, such as regulating the amount of discharged anode off-gas, are performed based on the corrected hydrogen concentration under normal operation conditions (that is, when the fuel cell is generating electricity) in and after step S102.

Next, correction of the hydrogen concentration sensor 3 will be described. The ECU 4 opens the release valve 5 provided on the anode off-gas passage 22 to start discharging the anode off-gas (S201). The ECU 4 measures the anode off-gas discharge amount (S202), and determines whether the discharge amount is equal to or greater than a predetermined amount (S203). If the result of determination in step S203 shows that the anode off-gas discharge amount is less than the predetermined amount, the correction of the sensor is not performed, and the routine is exited.

On the other hand, if the result of determination in step S203 shows that the anode off-gas discharge amount is equal to or greater than the predetermined amount, the hydrogen concentration is measured to perform correction of the hydrogen concentration sensor 3 (S204). The predetermined amount is such that the hydrogen concentration measured by the hydrogen concentration sensor 3, that is, the hydrogen concentration in the anode off-gas passage 22 is supposed to become substantially 100% when the anode off-gas has been discharged by the predetermined amount. The predetermined amount is preset.

If the hydrogen concentration measured in step S204 is not 100%, the difference between the measurement value and 100%, which is a theoretical value, is an error, and the value obtained by dividing 100%, which is a theoretical value, by the actual measurement value is set as the correction value α (S205).

The value that is obtained by dividing the theoretical value of the hydrogen concentration, which is 100% in this embodiment, at the time point the anode off-gas has been discharged by the predetermined amount by the actual measurement value at the same time point, is the correction value α, which is the value by which the measurement value is multiplied at the time of the correction of the hydrogen concentration in step S102.

The measurement value from the hydrogen concentration sensor 3 is multiplied by the thus calculated correction value α when the various control operations are performed based on the hydrogen concentration in the anode off-gas passage 22 (S102). Thus, it is made possible to appropriately correct the error of the hydrogen concentration sensor 3, and to correct the reference point of the hydrogen concentration sensor 3. Even if the hydrogen concentration sensor 3 is used for a long time and becomes degraded over time, it is possible to correct the error due to degradation by appropriately performing the correction of the sensor.

Although the value calculated in step S205, that is, the value calculated after a single measurement, is used as the correction value in this embodiment, the average value obtained by calculating the correction value a plurality of times and averaging the calculated correction values may be used as the correction value, for example. In addition, the upper and lower limits of the correction value may be set. By appropriately setting the correction value in this way, it is possible to improve the measurement accuracy of the hydrogen concentration sensor and further suppress the measurement error.

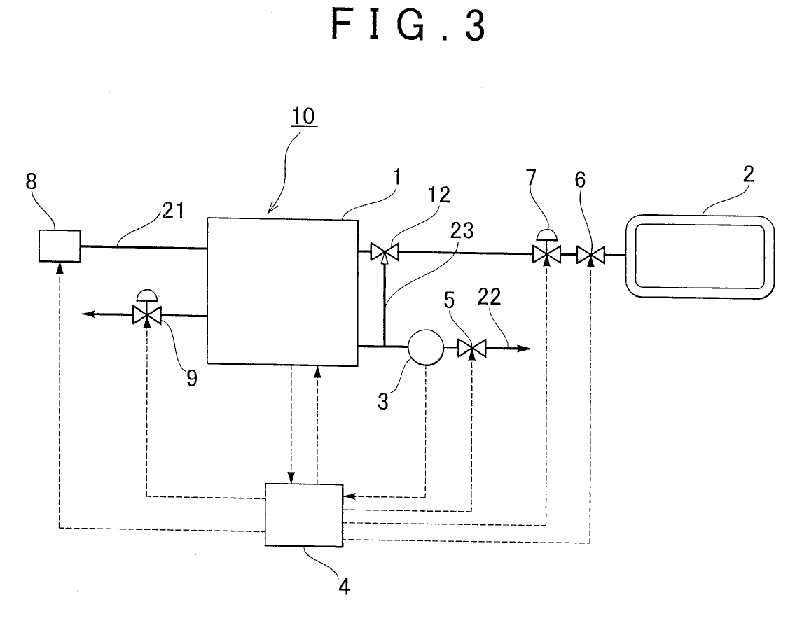

In the above-described embodiment, the anode off-gas discharged from the fuel cell 1 is discharged from the system by the predetermined amount, and the correction is then performed on the assumption that the hydrogen concentration in the anode off-gas passage 22 is a certain constant concentration. As shown in FIG. 3, however, a bypass passage 23 that leads the hydrogen gas supplied from the high-pressure hydrogen tank 2 directly (not through the fuel cell) to the anode off-gas passage 22 may be provided. If the bypass passage 23 is provided, the hydrogen gas introduced into the anode off-gas passage 22 through the bypass passage 23 contains little moisture, and thus, it is possible to reduce the influence of moisture on the hydrogen concentration sensor 3, which makes it possible to improve the measurement accuracy.

A control valve 12 for switching between the supply passages of the hydrogen gas to the bypass passage and to the fuel cell stack may be provided. It is also preferable that the bypass passage 23 be closed during normal electricity generation, and, when the reference point of the hydrogen concentration sensor is corrected, the hydrogen gas be supplied to the bypass passage, and the supply of the hydrogen gas from the high-pressure hydrogen tank 2 to the fuel cell stack be cut off, using the control valve 12.

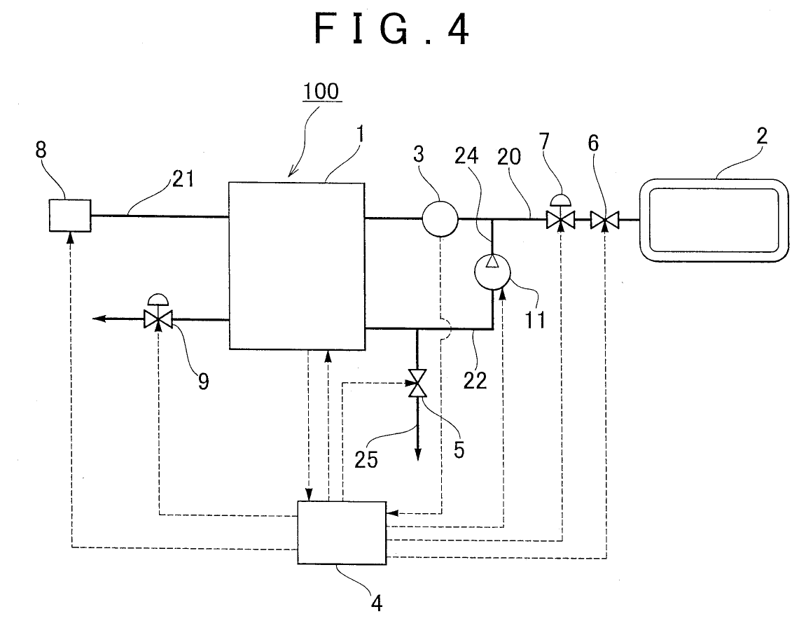

FIG. 4 is a configuration diagram of a fuel cell system according to a second embodiment. The fuel cell system 100 includes: a fuel cell 1 that generates electricity through electrochemical reactions between a hydrogen gas and an oxidizing gas; a high-pressure hydrogen tank 2 as a hydrogen supply device that supplies the hydrogen gas to the fuel cell 1, the high-pressure hydrogen tank 2 storing the hydrogen gas as a fuel gas; a release valve 6 of the high-pressure hydrogen tank 2; a regulator valve 7 for regulating the pressure of the hydrogen gas discharged from the high-pressure hydrogen tank 2; an oxidizing gas supply passage 21 through which air to be supplied to the fuel cell 1 passes; an air compressor 8, provided on the oxidizing gas supply passage 21, that supplies the oxidizing gas to the fuel cell 1; a hydrogen supply passage 20 through which the hydrogen gas passes that is supplied from the high-pressure hydrogen tank 2 to the fuel cell 1; an anode off-gas passage 22 through which anode off-gas discharged from the anode side of the fuel cell 1 passes; a hydrogen circulation passage 24 that connects between the anode off-gas passage 22 and the hydrogen supply passage 20; a hydrogen pump 11, provided on the hydrogen circulation passage 24, that introduces the anode off-gas to the hydrogen supply passage 20; a hydrogen concentration sensor 3 provided downstream of the joining of the hydrogen supply passage 20 and the hydrogen circulation passage 24 on the hydrogen supply passage 20; a release valve 5, provided on an anode off-gas-discharging passage 25 branching off from the anode off-gas passage 22, for discharging the anode off-gas from the system; a regulator valve 9 for regulating the pressure of the cathode off-gas discharged from the cathode side of the fuel cell 1; and an ECU 4 that performs various control operations, such as control of hydrogen gas supply by the high-pressure hydrogen tank 2.

The fuel cell 1 obtains electric energy through electrochemical reactions between the hydrogen gas supplied from the high-pressure hydrogen tank 2 and the oxidizing gas supplied through the oxidizing gas passage 21. The anode off gas containing remaining hydrogen that was not used to generate electricity and nitrogen that has passed through the electrolyte film of the fuel cell 1 is discharged from the anode (fuel electrode) side of the fuel cell 1 through the anode off-gas passage 22.

The anode off-gas passage 22 connects with the anode off-gas-discharging passage 25 for discharging the anode off-gas, and it is possible to discharge the anode off-gas from the system by performing opening/closing operation of the release valve 5. However, the anode-off gas contains hydrogen, and, if the anode off-gas is discharged as it is, high concentration hydrogen gas can be discharged from the system. Therefore, in order to return the anode-off gas to the fuel cell 1, the hydrogen circulation passage 24 connecting the anode off-gas passage 22 and the hydrogen supply passage 20 is provided. The hydrogen circulation passage 24 is provided with the hydrogen pump 11, and the anode off-gas is introduced into the hydrogen supply passage 20, as needed using the hydrogen pump 11, thereby supplying the anode off-gas to the fuel cell 1.

The fuel cell system 100 according to the second embodiment introduces the hydrogen gas from the high-pressure hydrogen tank 2 or the anode off-gas from the hydrogen circulation passage 24 to the fuel cell 1 after appropriate regulation based on the electricity generation conditions of the fuel cell 1, the hydrogen concentration in the anode off-gas, etc.

The hydrogen concentration sensor 3 measures the hydrogen concentration in the hydrogen gas that is supplied to the fuel cell 1 through the hydrogen supply passage 20. The value measured by the hydrogen concentration sensor 3 is input to the ECU 4. When the electricity generation process in the fuel cell 1 is taking place, the ECU 4 performs various control operations, such as the control operation in which the flow rate of the anode off-gas that is circulated using the hydrogen pump 11 is regulated based on the hydrogen concentration to prevent the hydrogen gas shortage in the fuel cell 1.

Because the measurement value from the hydrogen concentration sensor 3 is used in the various control operations of the fuel cell system 100, it is preferable that the measurement accuracy of the hydrogen concentration sensor 3 be high. However, it is possible that the hydrogen concentration sensor 3 becomes degraded after long-term use, and the measurement accuracy is thus reduced. With the second embodiment, an error of the hydrogen concentration sensor 3 is corrected.

Specifically, a predetermined amount of hydrogen gas from the high-pressure hydrogen tank 2 only is supplied to the fuel cell 1 (without supplying the anode off-gas) to realize a condition in which it is possible to assume that the hydrogen concentration near the hydrogen concentration sensor 3 is substantially 100%. Under the condition, the hydrogen concentration is actually measured using the hydrogen concentration sensor 3. If the measured hydrogen concentration is not 100%, which is a theoretical value, it is judged that there occurs an error, and the correction value for the hydrogen concentration sensor 3 is calculated. The various control operations of the fuel cell system 100, such as regulating the flow rate of the anode off-gas that is introduced into the fuel cell 1, are performed based on the hydrogen concentration that reflects the calculated correction value.

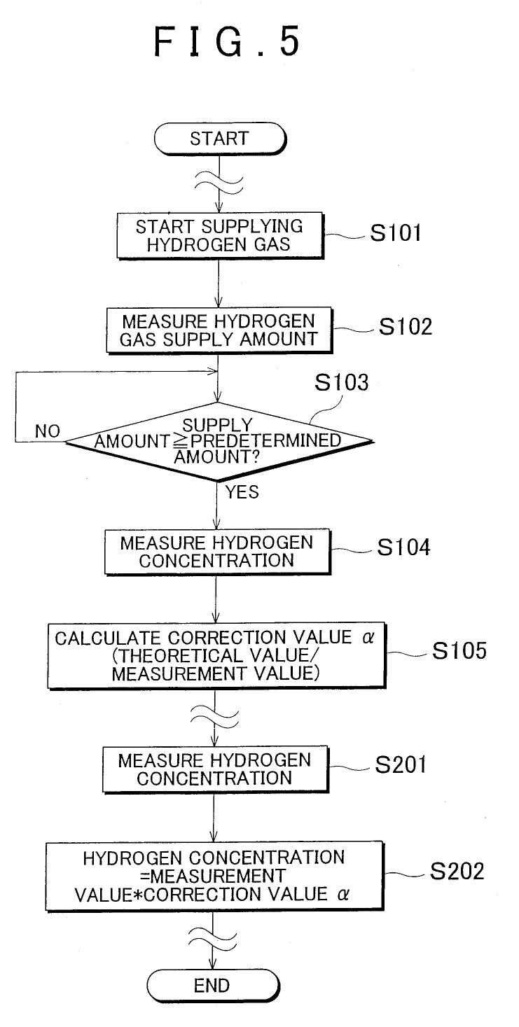

Correction of the hydrogen concentration sensor 3 according to the second embodiment will be described in detail below with reference to the flow chart shown in FIG. 5. This control is realized by a routine that is executed by the ECU 4.

The correction of the hydrogen concentration sensor 3 is performed when the fuel cell 1 starts generating electricity. While the electricity generation is stopped, the gas pressure in the fuel cell 1 is lower than that when the electricity generation process is taking place. If hydrogen gas is supplied under this condition, pure hydrogen gas flows through the hydrogen supply passage 20 provided with the hydrogen concentration sensor 3, and it is therefore possible to make the hydrogen concentration near the hydrogen concentration sensor 3 substantially 100%.

Upon receiving a start signal, the ECU 4 starts supplying hydrogen gas from the high-pressure hydrogen tank 2 (S101). It should be noted that, because step S101 is performed before the fuel cell 1 starts generating electricity, and the hydrogen pump 11 is therefore at a stop, only the hydrogen gas from the high-pressure hydrogen tank 2 flows into the hydrogen supply passage 20.

Subsequently, the ECU 4 measures the amount of the hydrogen gas supplied from the high-pressure hydrogen tank 2 (S102). By measuring the amount of the hydrogen gas, it is possible to estimate the timing at which the hydrogen concentration near the hydrogen concentration sensor 3 becomes substantially 100%. The ECU 4 waits until the amount of the hydrogen gas that has been supplied from the high-pressure hydrogen tank 2 becomes a predetermined amount (S103). The ECU 4 then measures the hydrogen concentration using the hydrogen concentration sensor 3 (S104).

The predetermined amount is such that the hydrogen concentration near the hydrogen concentration sensor 3 is supposed to become 100% when the hydrogen gas has been supplied by the predetermined amount. The hydrogen concentration is actually measured when the hydrogen gas has been supplied by the predetermined amount, and, if the measurement value differs from 100%, which is a theoretical value, the measurement value from the hydrogen concentration sensor is corrected.

The ECU 4 calculates a correction value a for correcting the error of the hydrogen concentration sensor 3 in the various control operations described later (S105). The value obtained by dividing, by the actual measurement value, the theoretical value (100% in this embodiment) of the hydrogen concentration after the hydrogen gas has been supplied by the predetermined amount is the correction value a, which is the value by which the measurement value is multiplied when the hydrogen concentration is corrected in step S202 described later. After the correction value a is calculated, the normal electricity generation process takes place.

The step S201 and subsequent steps are performed while electricity is generated. The ECU 4 measures the hydrogen concentration in the hydrogen supply passage 20 using the hydrogen concentration sensor 3 for the purpose of regulating the flow rate of the anode off-gas that is introduced into the fuel cell 1 based on the hydrogen concentration.

Subsequently, the measurement value obtained in step S201 is multiplied by the correction value a that has been calculated in step S105, thereby setting the hydrogen concentration that is used as a reference in controlling the flow rate at which hydrogen circulates (S202). In this way, it becomes possible to appropriately correct the error of the hydrogen concentration sensor 3, that is, to correct the reference point of the hydrogen concentration sensor 3. By appropriately performing the correction of the hydrogen concentration sensor 3, it becomes possible to correct the error and maintain the measurement accuracy even if the hydrogen concentration sensor is used for a long time and becomes degraded.

Although the value calculated in step S105, that is, the value calculated after a single measurement, is used as the correction value α in the second embodiment, the average value obtained by calculating the correction value a plurality of times and averaging the calculated correction values may be used as the correction value, for example. In addition, the upper and lower limits of the correction value may be set. By appropriately setting the correction value in this way, it is possible to improve the measurement accuracy of the hydrogen concentration sensor and further suppress the measurement error.

In the above-described embodiment, the timing at which the hydrogen concentration near the hydrogen concentration sensor 3 becomes substantially 100% is determined based on the amount of hydrogen gas supplied. However, in the present invention, it suffices that the fuel cell system have a configuration capable of determining the timing at which the hydrogen concentration near the hydrogen concentration sensor 3 becomes a predetermined concentration; the present invention is not limited by the configuration in which the control is performed using the supply amount. For example, the timing at which the hydrogen concentration becomes substantially 100% may be determined based on the time elapsed since supplying hydrogen was started.

While the invention has been described with reference to what are considered to be preferred embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more, less or only a single element, are also within the scope of the invention.

1. A method of controlling a fuel cell system including a fuel cell that generates electricity through electrochemical reactions between a hydrogen gas and an oxidizing gas, comprising:
supplying the hydrogen gas to the fuel cell from a hydrogen supply device through a hydrogen supply passage;
discharging an anode off-gas from the anode side of the fuel cell into an anode off-gas passage;
reducing impurities in the passage provided with a hydrogen concentration sensor, the passage being at least one of the hydrogen supply passage and the anode off-gas passage; and,
when the impurities have been reduced, measuring the hydrogen concentration using the hydrogen concentration sensor, and correcting, by a correction value obtained based on the measured actual hydrogen concentration, and a supposed measurement value, which is a theoretical value, a reference point of the hydrogen concentration sensor.

2. The method of controlling the fuel cell system according to claim 1, wherein
the fuel cell system includes a release valve that discharges the impurities contained in the anode off-gas from the system, and
the measuring the hydrogen concentration is performed upstream of the release valve in the anode off-gas passage after the release valve is opened and the anode off-gas has been discharged by a predetermined amount while supplying the hydrogen gas using the hydrogen supply device.

3. The method of controlling the fuel cell system according to claim 1, wherein
the fuel cell system includes: a hydrogen circulation passage that connects the hydrogen supply passage and the anode off-gas passage, and leads the anode off-gas to the hydrogen supply passage; and
the measuring the hydrogen concentration is performed downstream of a joining of the hydrogen supply passage and the hydrogen circulation passage in the hydrogen supply passage after the impurities have been reduced by supplying the hydrogen gas to the fuel cell while regulating the flow of the anode off-gas from the hydrogen circulation passage into the hydrogen supply passage.

4. The method of controlling the fuel cell system according to claim 1, wherein
the correction value used to correct the reference point of the hydrogen concentration sensor is calculated by dividing, by the actual measurement value, the supposed measurement value, that is a theoretical value supposed to be obtained when the impurities have been reduced.

5. The method of controlling the fuel cell system according to claim 1, wherein
the reference point of the hydrogen concentration sensor is corrected by multiplying the correction value with said actual measurement value.

6. A fuel cell system comprising:
a fuel cell that generates electricity through electrochemical reactions between a hydrogen gas and an oxidizing gas;
a hydrogen supply device that supplies the hydrogen gas to the fuel cell;
a hydrogen supply passage through which the hydrogen gas supplied from the hydrogen supply device passes;
an anode off-gas passage through which an anode off-gas discharged from the anode side of the fuel cell passes;
a hydrogen concentration sensor provided on at least one of the hydrogen supply passage and the anode off-gas passage; and
a correction device that reduces impurities in the passage provided with the hydrogen concentration sensor; measures hydrogen concentration using the hydrogen concentration sensor, and corrects, by a correction value obtained based on the measured actual hydrogen concentration and a supposed measurement value, which is a theoretical value, a reference point of the hydrogen concentration sensor.

7. The fuel cell system according to claim 6, further comprising:
a release valve, provided on the anode off-gas passage, that discharges the impurities contained in the anode off-gas from the system, wherein
the hydrogen concentration sensor is provided upstream of the release valve on the anode off-gas passage, and the impurities are reduced by discharging the anode off-gas by a predetermined amount or more by opening the release valve, while supplying the hydrogen gas using the hydrogen supply device.

8. The fuel cell system according to claim 7, further comprising:
a bypass passage that leads the hydrogen gas to the anode off-gas passage not through the fuel cell, the bypass passage connecting the hydrogen supply passage and a portion of the anode off-gas passage that is located upstream of the hydrogen concentration sensor, wherein,
when the correction device has discharged the anode off-gas by the predetermined amount or more while supplying the hydrogen gas to the anode off-gas passage through the bypass passage, the correction device measures the hydrogen concentration using the hydrogen concentration sensor, and corrects the reference point of the hydrogen concentration sensor.

9. The fuel cell system according to claim 8, further comprising:
a control valve that switches between the supply passages of the hydrogen gas to the bypass passage and to the fuel cell.

10. The fuel cell system according to claim 7, wherein
the predetermined amount by which the anode off-gas is discharged is such that the hydrogen concentration measured by the hydrogen concentration sensor is supposed to become substantially 100% when the anode off-gas is discharged by the predetermined amount.

11. The fuel cell system according to claim 6, further comprising:
a hydrogen circulation passage that connects the hydrogen supply passage and the anode off-gas passage, and leads the anode off-gas to the hydrogen supply passage, wherein
the hydrogen concentration sensor is provided downstream of a joining of the hydrogen supply passage and the hydrogen circulation passage on the hydrogen supply passage, and the impurities are reduced by supplying the hydrogen gas to the fuel cell while regulating the flow of the anode off-gas from the hydrogen circulation passage into the hydrogen supply passage.

12. The fuel cell system according to claim 6, wherein
the correction device corrects the reference point of the hydrogen concentration sensor when an electricity generation process in the fuel cell is started.

13. The fuel cell system according to claim 11, wherein
when the correction device has supplied the hydrogen gas to the fuel cell by a predetermined amount or more using the hydrogen supply device, the correction device measures the hydrogen concentration using the hydrogen concentration sensor, and corrects the reference point of the hydrogen concentration sensor.

14. The fuel cell system according to claim 13, wherein
the predetermined amount by which the hydrogen gas is supplied is such that the hydrogen concentration measured by the hydrogen concentration sensor is supposed to become substantially 100% when the hydrogen gas has been supplied by the predetermined amount.

15. The fuel cell system according to claim 6, wherein
the correction device calculates the correction value used to correct the reference point of the hydrogen concentration sensor by dividing, by the actual measurement value, the supposed measurement value that is a theoretical value supposed to be obtained when the impurities have been reduced.

16. The fuel cell system according to claim 15, wherein
the correction device calculates the correction value a plurality of times, and corrects the reference point of the hydrogen concentration sensor based on the average value of the calculated correction values.

17. The fuel cell system according to claim 15, wherein,
only when the correction value is within a predetermined range, the correction device corrects the reference point of the hydrogen concentration sensor based on the correction value.

18. The method of controlling the fuel cell system according to claim 6, wherein
the reference point of the hydrogen concentration sensor is corrected by multiplying the correction value with said actual measurement value.
